(19) United States
(12) Patent Application Publication
(10) Pub. No.: US 2017/0288554 A1
(43) Pub. Date: Oct. 5, 2017

(54) Power Converter And Power Conversion Method

(71) Applicant: Infineon Technologies Austria AG, Villach (AT)

(72) Inventors: Marc Fahlenkamp, Geretsried (DE); Torsten Hinz, Augsburg (DE); Martin Krueger, Oberschleissheim (DE); Anders Lind, San Jose, CA (US); Jon Mark Hancock, Livermore, CA (US); Allan Saliva, Milpitas, CA (US)

(21) Appl. No.: 15/087,256

(22) Filed: Mar. 31, 2016

(51) Int. Cl. H02M 3/335; H02M 1/08

(52) U.S. Cl. CPC H02M 3/33515; H02M 1/08; H02M 2001/0009

(57) ABSTRACT

In accordance with an embodiment, a power conversion method includes operating a power converter circuit in one of a first operation and a second operation mode based on a feedback signal and a signal level of an output signal at an output. The power converter includes a transformer with a primary winding and a secondary winding, a first electronic switch connected in series with the primary winding, and a rectifier circuit connected between the secondary winding and the output and comprising a second electronic switch. The feedback signal is dependent on the output signal

### TECHNICAL FIELD

Examples of the present invention relate to a power converter, in particular a flyback converter, and a power conversion method.

### BACKGROUND

Switched mode power converters (switched mode power supplies, SMPS) are widely used for power conversion in automotive, industrial, or consumer electronic applications. A flyback converter is a specific type of switched mode voltage converter which includes a transformer with a primary winding and a secondary winding that have opposite winding senses. A first electronic switch is connected in series with the primary winding on a primary side of the power converter, and a rectifier circuit is coupled to the secondary winding on a secondary side of the power converter. The transformer is magnetized when the electronic switch is closed and demagnetized when the electronic switch is opened. Magnetizing the transformer includes storing energy in the transformer, and demagnetizing the transformer includes transferring the stored energy to the secondary winding, the rectifier circuit and a load coupled to the rectifier circuit.

The rectifier circuit may include an active rectifier element, which is often referred to as synchronous rectifier (SR). This active rectifier element includes a second electronic switch which switches on when a voltage across the electronic switch has a first polarity and switches off when the voltage has a second polarity opposite the first polarity. The rectifier circuit may further include a capacitor. Switching on the first electronic on the primary side and the second electronic switch on the secondary side may cause the capacitor to be rapidly discharged, which is highly undesirable as this may damage the power converter.

### SUMMARY

One example relates to a power converter. The power converter includes a primary winding and a secondary winding, a first electronic switch connected in series with the primary winding, a rectifier circuit connected between the secondary winding and an output, a feedback circuit, and a first control circuit. The rectifier circuit includes a second electronic switch, the feedback circuit is coupled to the output and configured to generate a feedback signal based on an output signal available at the output, and the first control circuit is configured to operate the power converter in one of a first operation and a second operation mode based on the feedback signal and a signal level of the output signal.

Another example relates to a power conversion method. The power conversion method includes operating a power converter in one of a first operation and a second operation mode based on a feedback signal and a signal level of an output signal at an output. The power converter includes a transformer with a primary winding and a secondary winding, a first electronic switch connected in series with the primary winding, and a rectifier circuit connected between the secondary winding and the output. The rectifier circuit includes a second electronic switch. The feedback signal is dependent on the output signal.

### BRIEF DESCRIPTION OF THE DRAWINGS

Examples are explained below with reference to the drawings. The drawings serve to illustrate certain principles, so that only aspects necessary for understanding these principles are illustrated. The drawings are not to scale. In the drawings the same reference characters denote like features.

FIG. 1 shows a power converter circuit with a flyback topology according to one example;

FIG. 2 shows one example of how an input voltage of the power converter shown in FIG. 1 can be generated;

FIG. 3 shows one example of a feedback circuit in the power converter circuit shown in FIG. 1;

FIG. 4 shows one example of a filter circuit shown in FIG. 3 in greater detail;

FIG. 5 shows one example of a rectifier circuit in the power converter circuit shown in FIG. 1;

FIG. 6 shows signal diagrams which illustrate operation of the power converter circuit;

FIG. 7 illustrates one example of a relationship between a feedback signal and a number of oscillation periods during a waiting time in a quasi-resonant (QR) mode of a power converter;

FIG. 8 shows a power converter circuit with a first control circuit according to one example;

FIG. 9 shows signal diagrams of signals occurring in the first control circuit shown in FIG. 8;

FIG. 10 shows a power converter circuit with a first control circuit according to another example; and

FIG. 11 shows a flowchart of a method for operating the power converter circuit.

### DETAILED DESCRIPTION OF ILLUSTRATIVE EMBODIMENTS

In the following detailed description, reference is made to the accompanying drawings. The drawings form a part of the description and by way of illustration show specific examples in which the invention may be practised. It is to be understood that the features of the various examples described herein may be combined with each other, unless specifically noted otherwise.

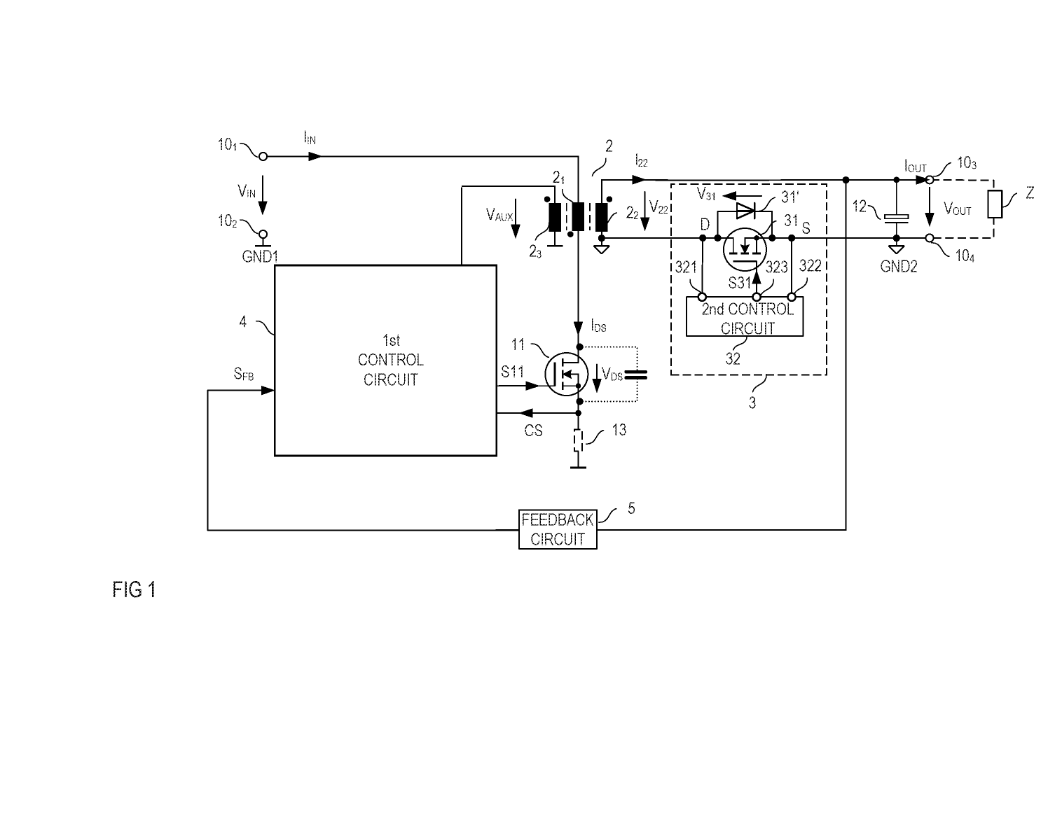

FIG. 1 shows a power converter (switched mode power supply, SMPS) according to one example. The power converter shown in FIG. 1 has a flyback converter topology and is briefly referred to as flyback converter in the following. The flyback converter includes an input configured to receive an input voltage V_{IN} and an input current I_{IN} and an output configured to provide an output voltage V_{OUT} and an output current I_{OUT}. The input may include a first input node 10₁ and a second input node 10₂, and the output may include a first output node 10₃ and a second output node 10₄. A load Z (illustrated in dashed lines in FIG. 1) may receive the output voltage V_{OUT} and the output current I_{OUT} available at the output. The flyback converter further includes a transformer 2 with a primary winding 2₁ and a secondary winding 2₂ magnetically coupled with the primary winding 2₁. The primary winding 2₁ and the secondary winding 2₂ have opposite winding senses. A first electronic switch 11 is connected in series with the primary winding 2₁ whereas the series circuit with the primary winding 2₁ and the electronic switch 11 is connected between the first and second input nodes 10₁, 10₂ to receive the input voltage V_{IN}. The transformer 2 galvanically isolates the input 10₁, 10₂ from the output 10₃, 10₄ so that the input voltage V_{IN} is referenced to a first ground node GND1, and the output voltage V_{OUT} is referenced to a second ground node GND2.

The flyback converter 1 further includes a rectifier circuit connected between the secondary winding 2₂ and the output 10₃, 10₄. In the example shown in FIG. 1, this rectifier circuit includes a series circuit with a capacitor 12 and an active rectifier circuit 3. This series circuit is connected in parallel with the secondary winding 2₂. The output voltage V_{OUT} is available across the capacitor 12, which is referred to as output capacitor in the following. The active rectifier circuit includes a second electronic switch 31 and a passive rectifier element 31′, such as a diode, connected in parallel with the second electronic switch. According to one example, the second electronic switch 31 is a MOSFET, in particular an enhancement (normally-off) MOSFET. A MOSFET, such as the MOSFET 31 shown in FIG. 1, includes an internal diode (often referred to as body diode) between a drain node and a source node. This internal diode may serve as the passive rectifier element 31′ so that no additional passive rectifier element is required when a MOSFET is used as the second electronic switch 31. The passive rectifier element 31′ shown in FIG. 1 may represent a discrete passive rectifier element or a body diode of a MOSFET. It is even possible to use a MOSFET as the second electronic switch 31 and connect a passive rectifier element 31′ additional to the body diode of the MOSFET in parallel with the MOSFET. For example, the passive rectifier element is a bipolar diode (as shown) or a Schottky diode.

The passive rectifier element 31′ (and the MOSFET 31, respectively) is connected such that the rectifier element 31′ in an off-state of the electronic switch 31 allows electrical power to be transferred unidirectionally from the secondary winding 2₂ to the output capacitor 12, but not from the output capacitor 12 to the secondary winding 2₂. In the example shown in FIG. 1, the second electronic switch 31 is an n-type MOSFET and is connected between the second output node 10₄ and the secondary winding 2₂; the second output node 10₄ is the negative output node. In order for the body diode of the MOSFET 31 to allow a power transfer from the secondary winding 2₂ to the output capacitor 12, the MOSFET 31 is connected such that its drain node D is coupled to the secondary winding 2₂ and its source node S is coupled to the second output node 10₄. The second electronic switch 31, however, is not restricted to be implemented using an n-type MOSFET. A p-type MOSFET, or another type of transistor may be used as well, such as an IGBT, a BJT (Bipolar Junction Transistor), a JFET (Junction Field Effect Transistor), or the like.

Referring to FIG. 1, the active rectifier circuit (which may also be referred to as synchronous rectifier circuit) includes a control circuit 32. At input nodes 321, 322 the control circuit 32 receives a voltage V₃₁ across the electronic switch 31 and the passive rectifier element 31′, respectively. The control circuit 32 is configured to drive the electronic switch 31 based on this voltage V₃₁, in particular, based on a polarity of this voltage V₃₁. For driving the second electronic switch 31 the second control circuit provides a second drive signal S31 at a drive output 323, the second electronic switch 31 receives the drive signal S32 at a control node, which is a gate node if the second electronic switch 31 is a MOSFET. Driving the second electronic switch 31 based on the voltage V₃₁ is explained in greater detail herein below.

A further control circuit 4 is configured to drive the first electronic switch 11 based on a feedback signal S received from a feedback circuit 5 and an auxiliary voltage V_{AUX} received from an auxiliary winding 2₃ of the transformer 2. In the following, the control circuit 4 that drives the first electronic switch 11 is referred to as a primary side control circuit or first control circuit, and the control circuit 32 that drives the second electronic switch 31 is referred to as a secondary side control circuit or second control circuit. The first control circuit 4 is configured to operate the first electronic switch 11 in a pulse-width modulated (PWM) fashion, as explained in further detail herein further below.

According to one example, the first electronic switch 11 is a transistor. In the example shown in FIG. 1, the transistor is a MOSFET (Metal Oxide Semiconductor Field-Effect Transistor), in particular an n-type enhancement MOSFET. However, this is only an example. Other types of transistors, such as an IGBT (Insulated Gate Bipolar Transistor), a JFET (Junction Field-Effect Transistor), a BJT (Bipolar Junction Transistor), or p-type MOSFET may be used as well.

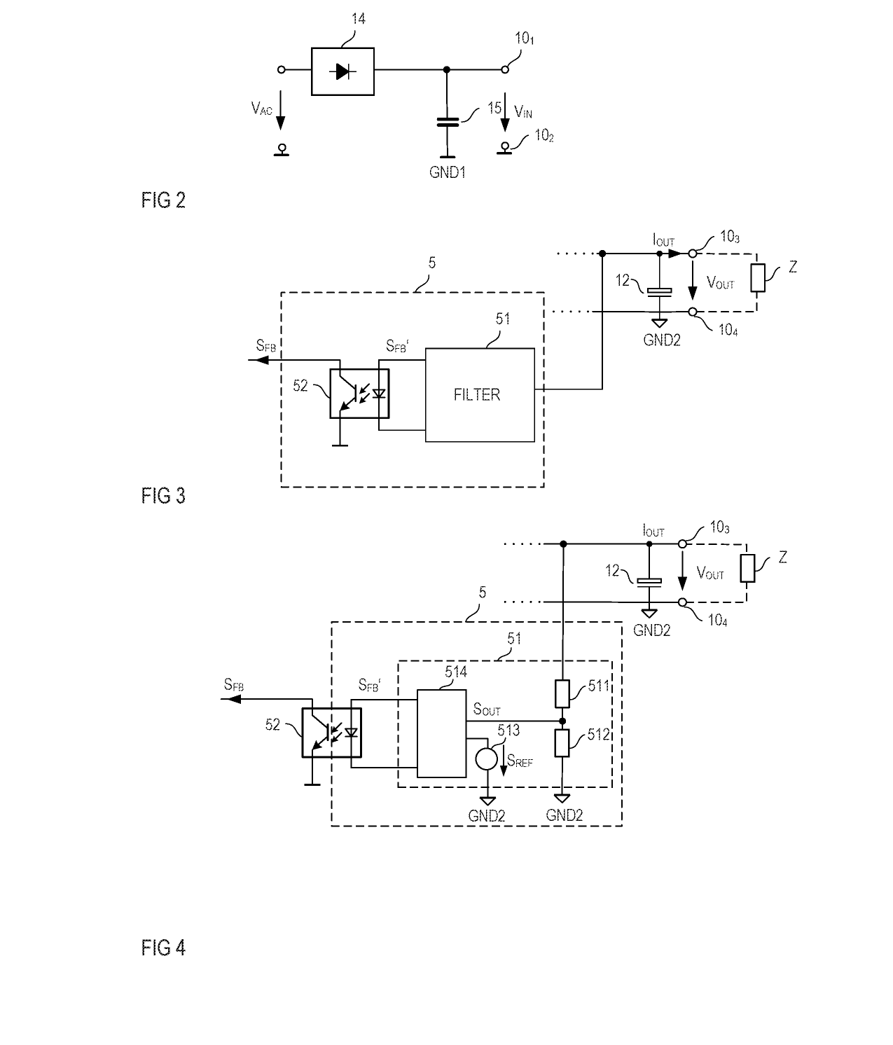

According to one example, the input voltage V_{IN} is a direct voltage (DC voltage). Referring to FIG. 2, this input voltage V_{IN} can be generated from an alternating voltage (AC voltage) V_{AC} by a rectifier circuit 14, such as a bridge rectifier with passive or active rectifier elements. A further capacitor 15, which is referred to as input capacitor in the following, may be connected between the input nodes 10₁, 10₂ to filter out ripples of the input voltage V_{IN}.

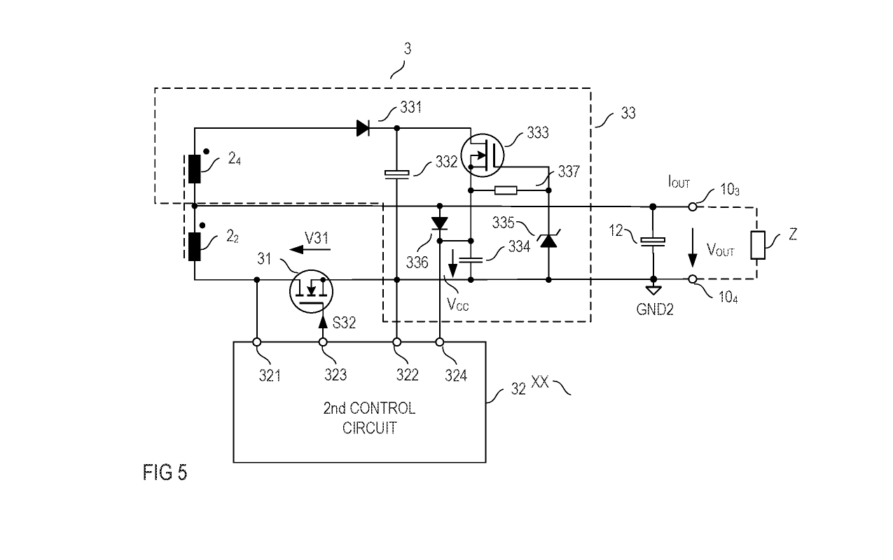

FIG. 3 shows one example of the feedback circuit 5, which generates the feedback signal S The feedback circuit may include a filter 51 that receives the output voltage V_{OUT}, and a transmitter 52. In the example shown in FIG. 3, the filter 51 is on the secondary side of the transformer 2, and the transmitter 52 transmits an output signal S_{FB}′ of the filter 51 from the secondary side to the primary side, whereas an output signal of the transmitter 52 is the feedback signal S received by the control circuit 4. The “primary side” of the power converter is formed by the primary winding 2₁ and circuitry connected to the primary winding 2₁, and the “secondary side” of the power converter is formed by the secondary winding 2₂ and circuitry connected to the secondary winding 2₂. In the example shown in FIG. 3, the transmitter 52 includes an optocoupler. However, this is only an example. Other transmitters suitable to transmit a signal via a potential barrier provided by a transformer may be used as well. Examples of such transmitter include a transmitter with a transformer, such as a coreless transformer. The filter 51 is configured to generate an error signal from the output voltage V_{OUT} and a reference signal, and generate the feedback signal S_{FB} based on the error signal. This is explained with reference to FIG. 4 below.

FIG. 4 shows one example of the filter 51 in greater detail. In this example, the filter includes an error filter 514 which receives a reference voltage S_{REF} from a reference voltage source 513 and either the output voltage V_{OUT} or a signal S_{OUT} proportional to the output voltage V_{OUT}. In the example shown in FIG. 4, the error filter receives a signal S_{OUT} proportional to the output voltage from a voltage divider 511, 512 connected between the output nodes 10₃, 10₃. The error filter is configured to calculate a difference between the signal S_{OUT} representing the output voltage V_{OUT} and the reference signal S_{REF}, and filter this difference in order to generate the filter output signal S_{FB}′. According to one example, the error filter 514 has one of a proportional (P) characteristic, a proportional-integral (PI) characteristic, and a proportional-integral, derivative (PID) characteristic. The transmitter 52 does not change the characteristic of the error filter 514 output signal S_{FB}′. In particular, the feedback signal S_{FB} output by the transmitter 52 to the first control circuit 4 can be substantially proportional to error filter 514 output signal S_{FB}′. Thus, in the following, the term “feedback signal” will be used for both, the signal output by the error filter 514 and the signal received by the first control circuit 4, although these signals are referenced to different ground potentials. The feedback signal S_{FB}′ output by the error filter 514 is referenced to the secondary side ground node GND2, while the feedback signal S_{FB} output by the transmitter circuit 52 and received by the first control circuit 4 is referenced to the primary side ground node GND1.

The reference signal S_{REF} defines a desired value (set value) of the output voltage. For example, if d is the divider ratio of the voltage divider 511, 512 so that S_{OUT}=d·V_{OUT}, then the set value of the output voltage V_{OUT} is given by S_{REF}/d.

According to another example (not shown), the positions of the filter 51 and the transmitter 52 in the feedback circuit 5 are changed so that the transmitter transmits a signal representing the output voltage V_{OUT} from the secondary side to the primary side and a filter receives the signal transmitted by the transmitter and generates the feedback signal S_{FB}.

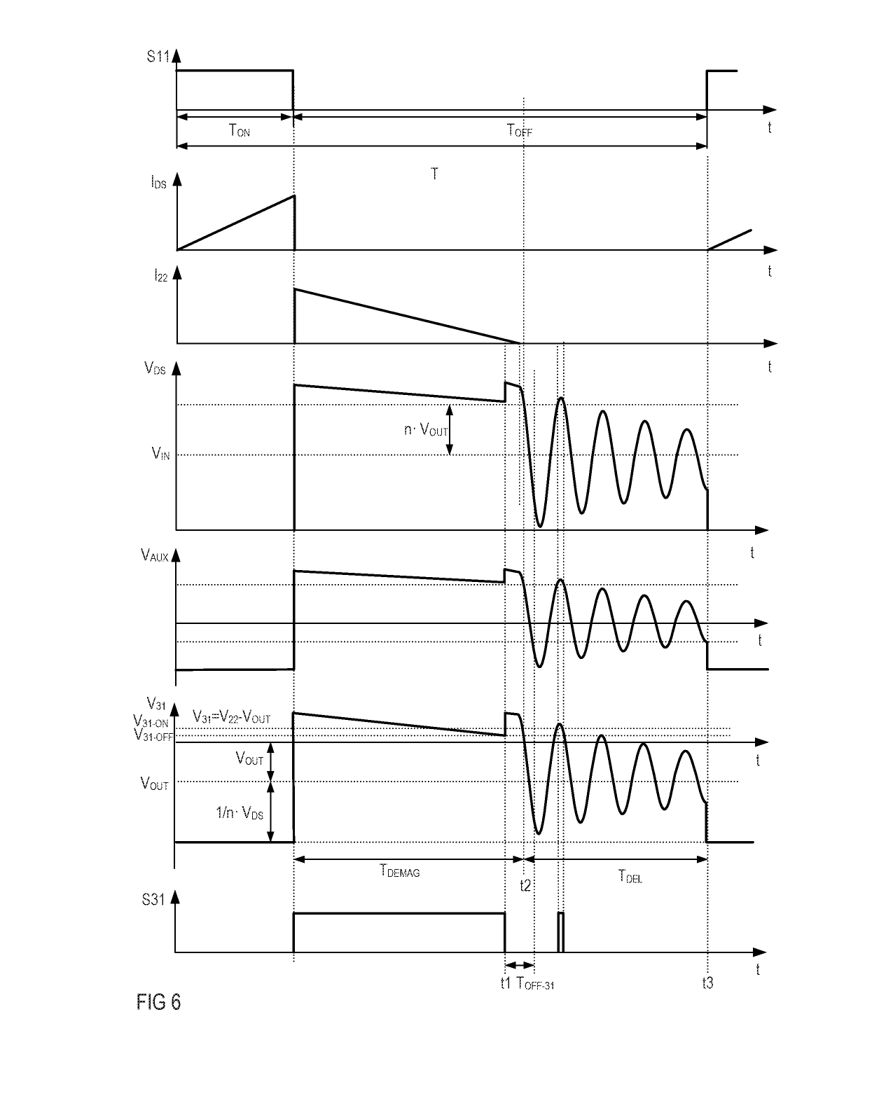

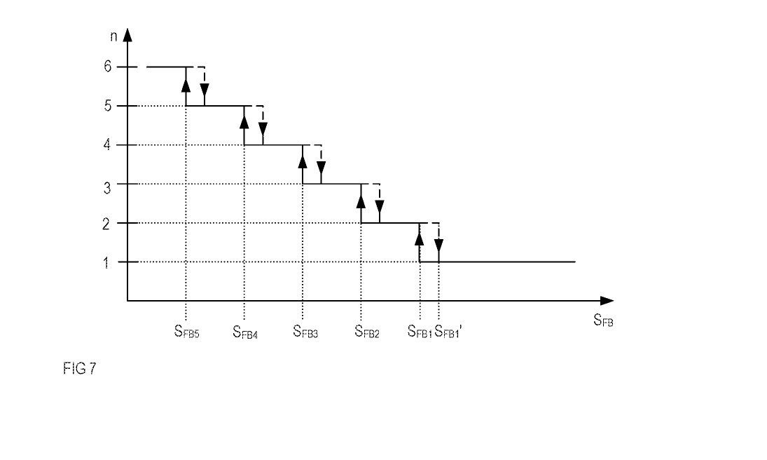

FIG. 5 shows another example of the active rectifier 3 circuit. In this example, the active rectifier circuit 3 includes an auxiliary power supply 33 configured to generate a supply voltage V_{CC} received by the second control circuit 32. The power supply includes a further auxiliary winding 2₄ inductively coupled with the primary winding 2₁ and the secondary winding of the transformer 2. In the following, the auxiliary winding 2₃ coupled to the first control circuit 4 and shown in FIG. 1 is referred to as first auxiliary winding and the auxiliary winding 2₃ of the auxiliary power supply 33 is referred to as second auxiliary winding. According to one example, the second auxiliary winding 2₄ and the secondary winding 2₂ have the same winding sense so that the auxiliary winding 2₄ receives power from the primary winding in the same way as the secondary winding 2₂. Details of this power transfer are explained with reference to FIG. 6 below.

Referring to FIG. 5, the auxiliary power supply 33 further includes a rectifier circuit with a rectifier element 331, such as a diode, and a first capacitor 332. In the example shown, a first circuit node of the auxiliary winding 2₄ is connected to the first output node 10₃ and a series circuit with the rectifier element 331 and the capacitor 332 is connected between a second circuit node of the auxiliary winding 2₄ and the second output node 10₄. The supply voltage V_{CC} is available across a second capacitor 344, which is connected to a supply input 324 of the second control circuit 32. This second capacitor 334 is referred to as output capacitor of the auxiliary power supply 33 in the following. A voltage regulator is connected between the first capacitor 332 and the output capacitor 334. This voltage regulator can be implemented as a linear voltage regulator as shown in FIG. 5. In this case, a transistor 333 such as a MOSFET has its load path (drain-source path) connected between the first capacitor 332 and the output capacitor 334 and is driven dependent on the supply voltage V_{CC} such that the transistor 333 blocks each time the supply voltage V_{CC} rises above a predefined threshold. The Zener diode 335 therefore clamps the electrical potential at the gate node of the transistor 333 to a value given by the Zener voltage of the Zener diode 335. For this, a voltage limiting element, such as a Zener diode 335 is connected between a gate node of the transistor 333 and that circuit node of the output capacitor 334 that faces away from the load path of the transistor 333. A resistor 337 connected between the output capacitor 334 and the Zener diode 335 biases the Zener diode, that is, via the resistor 337 the Zener diode 335 receives a current required by the Zener diode 335 to clamp the electrical potential at the gate node of the transistor 333. According to one example, the transistor 333 is a depletion transistor such as a depletion MOSFET. Optionally, the output capacitor 334 is further coupled to the first output node 10₃ via a rectifier element 336, such as a diode, so as to receive the output voltage V_{OUT}. In this way the control circuit 32 is supplied by both the auxiliary power source 33 and the output 10₃, 10₄ of the power converter.

One way of operating the flyback converter is explained with reference to FIG. 6 below. FIG. 6 shows timing diagrams of a first drive signal S11 of the first electronic switch 11, a current I_{DS} through the primary winding 2₁, a current I₂₂ through the secondary winding 2₂, a load path voltage V_{DS} across a load path of the first electronic switch 11, an auxiliary voltage V_{AUX} across the first auxiliary winding 2₃ of the transformer, the voltage V₃₁ across the second electronic switch 31 in the active rectifier circuit 3, and the second drive signal S31 of the second electronic switch 31. In the MOSFET forming the first electronic switch 11 shown in FIG. 1, the load path voltage V_{DS} is the drain-source voltage, and the load current I_{DS} is the drain-source current. The first drive signal S11 is generated by the first control circuit 4 and is received by a gate node of the MOSFET 11. The drive signal S11 may have one of a first signal level that switches on the electronic switch 11, and a second signal level that switches off the electronic switch 11. The first level is referred to as on-level and the second signal level is referred to as off-level in the following. Just for the purpose of explanation, in the example shown in FIG. 6, the on-level of the drive signal S11 is drawn as a high signal level and the off-level is drawn as a low level.

Operating the flyback converter includes a plurality of successive drive cycles, wherein in FIG. 6 only one of these drive cycles is shown. In each drive cycle the control circuit 4 switches on the first electronic switch 11 for an on-period T_{ON} and, after the on-period T_{ON}, switches off the first electronic switch 11 for an off-period T_{OFF}. During the on-period T_{ON}, the input voltage V_{IN} causes the load current I_{DS} to flow through the primary winding 2₁ and the first electronic switch 11, whereas a current level of the load current I_{DS} increases during the on-period T_{ON1} This increasing load current I_{DS} is associated with an increasing magnetization of the transformer 2. Such magnetization is associated with magnetically storing energy in the transformer 2 (more precisely, in an air gap of the transformer 2), whereas the stored energy increases as the load current I_{DS} increases. During the on-period T_{ON}, the load path voltage V_{DS} of the electronic switch 11 is substantially zero (if an ohmic resistance of the first electronic switch 11 in the on-state is neglected), and a voltage across the primary winding 2₁ substantially equals the input voltage V_{IN}. In the example shown in FIG. 1, the first auxiliary winding 2₃ and the primary winding 2₁ have opposite winding senses. In this case, a voltage level of the auxiliary voltage V_{AUX} is given by

V_{AUX}=−(N_{AUX}/N₂₁)·V₂₁ (1a),

where N_{AUX} is the number of windings of the first auxiliary winding 2₃, N₂₁ is the number of windings of the primary winding 2₁, and V₂₁ is the voltage across the primary winding. Thus, during the on-period T_{ON}, the voltage level of the auxiliary voltage V_{AUX} is given by

V_{AUX}=−(N_{AUX}/N₂₁)·V_{IN} (1b).

When the first electronic switch 11 switches off, the energy stored in the transformer 2 is transferred to the secondary winding 2₂, the rectifier circuit with the output capacitor 12 and the active rectifier 3, and the load Z, respectively. This causes the transformer 2 to be demagnetized. In FIG. 6, T_{DEMAG} denotes a time period in which the transformer 2 is demagnetized, that is, in which energy is transferred to the secondary side of the transformer 2. In this time period T_{DEMAG}, which is also referred to as demagnetizing period in the following, the load path voltage V_{DS} substantially equals the input voltage V_{IN} plus a reflected voltage V_{REFLECT}. The reflected voltage V_{REFLECT} is substantially given by

V_{REFLECT}=n·(V_{OUT}+V₃₁)=N₁/N₂·(V_{OUT}+V₃₁) (2),

where n is a winding ratio of transformer, which is given by n=N₁/N₂, with N₁ being the number of windings of the primary winding 2₁, and N₂ being the number of windings of the secondary winding 2₂. V₃₁ is the voltage across the second electronic switch 31 in the active rectifier 3. This voltage V₃₁ across the second electronic switch 31 is dependent on a current level of a current I₂₂ through the secondary winding 2₂. This current I₂₂ decreases over the demagnetizing period T_{DEMAG}, so that the reflected voltage V_{REFLECT} decreases and, at the end of the demagnetizing period T_{DEMAG}, reaches n·V_{OUT}.

Referring to FIG. 6, the drive signal S31 generated by the second control circuit 32 and driving the second electronic switch 31 may have one of a first signal level that switches on the second electronic switch 31, and a second signal level that switches off the second electronic switch 31. The first level is referred to as on-level and the second signal level is referred to as off-level in the following. Just for the purpose of explanation, in the example shown in FIG. 6, the on-level of the second drive signal S31 is drawn as a high signal level and the off-level is drawn as a low level. According to one example, the second control circuit 32 is configured to switch on the second electronic switch 31 when the voltage across the second electronic switch has a predefined polarity and when an absolute value of this voltage V₃₁ rises above a predefined first threshold V_{31-ON}, and switch off the second electronic switch 31 when the absolute value of this voltage V₃₁ falls below a predefined second threshold V_{31-OFF}. In the following, the first threshold V_{31-ON} is referred to as on-threshold and the second threshold V_{31-OFF} is referred to as off-threshold. According to one example, the on-threshold and the off-threshold are equal. According to another example, the on-threshold is higher than the off-threshold. This causes a hysteresis in the switching characteristic and may help to prevent the second electronic switch 31 from frequently switching on and off when the voltage V₃₁ is in the range of the on-threshold V_{31-ON}.

The predefined polarity of the voltage V₃₁ at which the second electronic switch 31 is allowed to switch on is a polarity that forward biases the passive rectifier element 31′, that is, is a polarity that occurs across the second electronic switch 31 when power is transferred from the secondary winding 2₂ to the output capacitor 12 and the load Z, respectively. Just for the purpose of illustration, in the figures the voltage V₃₁ is drawn such that it forward biases the passive rectifier element 31′ when it is positive. Switching on the second electronic switch 31 when the passive rectifier element 31′ is forward biased causes the current I₂₂ at least partially to bypass the passive rectifier element 31′ and flow through the second electronic switch 31. By this, conduction losses can be reduced as compared to a power converter that only includes a passive rectifier element instead of the active rectifier 3.

Referring to FIG. 6, the voltage V₃₁ across the second electronic switch 31 has the predefined polarity (turns positive) and its absolute value rises above the on-threshold V_{31-ON} at the beginning of the demagnetization period T_{DEMAG}, so that the second control circuit 32 switches on the second electronic switch 32. This is illustrated in FIG. 6 by the second drive signal S31 changing to the on-level. In the on-state of the second electronic switch 32 (that is, when the second electronic switch 32 has been switched on) the absolute value of the voltage V₃₁ across the second electronic switch is substantially given by an on-resistance of the second electronic switch 31 multiplied by the current I₂₂. As, referring to the explanation above, the current I₂₂ decreases over the demagnetization period T_{DEMAG}, the absolute value of the voltage V₃₁ decreases over the demagnetization period T_{DEMAG}. The “on-resistance” is the ohmic resistance of the second electronic switch 32 in the on-state. This on-resistance is mainly dependent on the specific type and design of the second electronic switch 32.

In FIG. 6, t1 denotes a time at which the absolute value of the voltage V₃₁ falls below the off-threshold V_{31-OFF} so that the second control circuit 32 switches off the second electronic switch 31 (the second drive signal S31 changes to the off-level). In the example shown in FIG. 6, the off-threshold V_{31-OFF} is different from zero, so that the first electronic switch 31 switches off before the voltage V₃₁ has decreased to zero, that is, before the transformer 2 has been demagnetized and the secondary side current I₂₂ has decreased to zero. The secondary side current I₂₂ then flows through the passive rectifier element 31′ (which can be the body diode of the MOSFET 31 shown in FIGS. 1 and 5) until the transformer 2 has been demagnetized and the secondary side current I₂₂ has decreased to zero. Redirecting the secondary side current I₂₂ from the second electronic switch 31 to the passive rectifier element 31′ causes the voltage V₃₁ across the parallel circuit with the first electronic switch 31 and the passive rectifier element 31′ to increase to at least the forward voltage of the passive rectifier element 31′. Thus, as shown in FIG. 6, the voltage V₃₁ jumps to at least the forward voltage of the passive rectifier element 31′ when the first electronic switch 31 switches off. At the end of the demagnetization period T_{DEMAG}, the voltage V₃₁ finally turns zero.

When the first electronic switch 31 switches off and the voltage V₃₁ jumps up the voltage V₃₁ may rise above the on-threshold V_{31-ON}. In order to prevent the first electronic switch 31 from again switching on towards the end of the demagnetization period T_{DEMAG}, the second control circuit 32, according to one example, is configured to keep the second electronic switch 31 switched off for a minimum off-period T_{31-OFF} after the first electronic switch 31 has been switched off. During this minimum off-period the secondary side current I₂₂ and, therefore, the voltage V₃₁ decreases to zero.

FIG. 6 illustrates an operation of the power converter circuit in a discontinuous conduction mode (DCM). In this operation mode, there is a waiting time T_{DEL} between a time t2 when the transformer 2 has been completely demagnetized and a time t3 when a next drive cycle starts by again switching on the first electronic switch 11. During the waiting time T_{DEL} the voltage V₂₁ across the primary winding 2₁ and the load path voltage V_{DS} of the first electronic switch 11 oscillate. This is due to a parasitic resonant circuit that includes the primary winding 2₁ of the transformer and a parasitic capacitance of the first electronic switch 11. This parasitic capacitance may include a capacitance in parallel with the load path of the first electronic switch 11. In the example shown in FIG. 1 this parasitic capacitance is drawn (in dotted lines) as a capacitor connected in parallel with the load path of the first electronic switch 11. By virtue of the magnetic coupling between the primary winding 2₁, the secondary winding 2₂, and the first auxiliary winding 2₃ the auxiliary voltage V_{AUX}, and the voltage V₂₂ across the secondary winding 2₂ oscillate in accordance with the load path voltage V_{DS}. The voltage V₃₁ across the second electronic switch 31 is given by the voltage V₂₂ across the secondary winding 2₂ minus the output voltage V_{OUT}(V₃₁=V₂₂−V_{OUT}) so that, during the waiting time T_{DEL}, the voltage V₃₁ across the second electronic switch 31 substantially oscillates around a voltage level given by the output voltage V_{OUT}.

In the DCM the power converter circuit can be operated in a fixed frequency mode or a variable frequency mode. In the fixed frequency mode, the first control circuit 4 switches on the first electronic switch 11 at a fixed switching frequency. The switching frequency is the reciprocal of the duration T of one drive cycle, so that the durations T of the drive cycles are constant in the fixed frequency mode. In the variable frequency mode the durations T of the drive cycles and, therefore, the switching frequency may vary. According to one example, in each of the fixed frequency mode and the variable frequency mode a duration T_{ON} of the on-period of the first electronic switch 11 is adjusted by the first control circuit 4 based on the feedback signal S_{FB}, which represents a power consumption of the load Z, that is, an output power of the power converter supplied to the load Z. When the power consumption of the load Z increases, a duration of the on-period T_{ON} increases so as to increase an input power of the power converter to satisfy the power consumption of the load; when the power consumption of the load Z decreases, the duration of the on-period T_{ON} decreases so as to decrease an input power of the power converter to satisfy the power consumption of the load.

One example of operating the power converter in the variable frequency mode is the quasi-resonant (QR) mode or valley mode, respectively. Referring to FIG. 6, the load path voltage V_{DS} after the demagnetization period periodically includes local minima or valleys. The first control circuit 4 is configured to detect those local minima and, in the QR mode, is configured to switch on the first electronic switch 11 at the time of one of these local minima. This is shown in FIG. 6, where the signal diagrams are based on an example where the control circuit 4 switches on the first electronic switch 11 at a time at which a fifth local minimum (valley) after the demagnetization period T_{DEMAG} occurs. In the QR mode, besides varying the on-period T_{ON} to vary the input power the first control circuit 4 may further vary the number of valleys that are allowed to pass before the electronic switch 11 switches on. Thus, switching on in the fifth valley, as shown in FIG. 6, is just an example. The number of valleys that are allowed to pass (four in the example shown in FIG. 6) before the first electronic switch 11 again switches on define the waiting time between the end of the demagnetization period T_{DEMAG} and the time of switching on the first electronic switch 11. This waiting period may vary dependent on the feedback signal S.

One example of varying the number of valleys that are allowed to pass based on the feedback signal is illustrated in FIG. 7, which shows the number n of the valley in which the electronic switch 11 switches on dependent on the feedback signal. In this example, n=1 means that the electronic switch switches on in the first valley after the transformer has been demagnetized. In this case, there are no oscillations of the load path voltage V_{DS} or, more precisely, there is substantially one half of one oscillation cycle of the load path voltage. If the feedback signal S_{FB} falls below a first threshold S_{FB1} the control circuit 4 starts to increase the waiting time, that is allows one valley to pass and switches on in the second valley. In FIG. 7 this is illustrated by n changing to n=2 at S_{FB}=S_{FB1}. If the feedback signal further decreases to a next threshold S_{FB2} the control circuit further increases the waiting time by allowing a further valley to pass before the electronic switch 11 switches on, and so on. Increasing the waiting time without increasing the on-period T_{ON} may result in a decreasing input power and. At a given power consumption of the load Z, a decreasing input power may result in a decreasing output voltage V_{OUT} and, therefore, an increasing feedback signal. Thus, after increasing the waiting time by increasing n the feedback signal may rise. In order to prevent the control circuit 4 from frequently switching between two different values of n the characteristic curve shown in FIG. 7, that maps values of the feedback signal S_{FB} to values of n, may include a hysteresis. By virtue of the hysteresis the control circuit 4 increases n if the feedback signal falls below a first threshold, S_{FB1} for example, but decreases n not until the feedback signal S_{FB} rises above another threshold, S_{FB1′} for example, higher than the threshold S_{FB}.

The oscillation frequency of the parasitic oscillations during the waiting time is substantially fixed and given by the specific type and design of those devices that cause the oscillations. According to one example, the control circuit 4 is configured to detect the valleys based on detecting those times when the auxiliary voltage V_{AUX} crosses zero in a certain direction (from positive to negative in the example shown in FIG. 6). A valley occurs substantially one quarter of one oscillation period after the zero crossing. The duration of one quarter of one oscillation period can be obtained by the first control circuit 4 by measuring the time distance between two subsequent zero crossings of the auxiliary voltage V_{AUX} and dividing the result by 2.

Referring the above, the voltage V₃₁ across the second electronic switch 31 is given by the voltage V₂₂ across the secondary winding 2₂ minus the output voltage V_{OUT}, so that after the demagnetization period T_{DEMAG}, the voltage V₃₁ oscillates around the output voltage V_{OUT}. The amplitude of those oscillations decreases over the waiting time. In the beginning, that is, right after the transformer 2 has been demagnetized the amplitude is substantially given by 1/n·V_{DS}, where n is the winding ratio of the transformer 2. For example, a rate at which the amplitude of the oscillations decreases is dependent on parasitic capacitances of the first electronic switch 11 and the second electronic switch 31, respectively.

In particular if the output voltage V_{OUT} is low the voltage V₃₁ may cross the on-threshold V_{31-ON} in one or more of the oscillation periods occurring during the waiting time T_{DEL}. In the example shown in FIG. 6, the voltage V₃₁ crosses the on-threshold V_{31-0N} in one of these oscillation periods, so that the first electronic switch 31 is switched on by the second drive signal S31 until the voltage V₃₁ falls below the off-threshold V_{31-OFF}. For example, a low voltage level of the output voltage V_{OUT}, which may cause the voltage V₃₁ to reach the on-threshold V_{31-ON} during the waiting time T_{DEL}, may occur during a start-up phase of the power converter or when a power consumption of the low Z rapidly increases or becomes higher than a rated output power of the power converter.

If the first electronic switch 11 switches on when the second electronic switch 31 during the waiting time T_{DEL} is in the on-state, the output capacitor 12 is rapidly discharged via the conducting second electronic switch 31. This may cause the power converter to be severely damaged or even destroyed. Thus, it is undesirable for the first electronic switch 11 and the second electronic switch 31 to be switched on at the same time. When the power converter circuit operates in the QR mode, there is almost no risk of the first electronic switch 11 and the second electronic switch 31 being switched on at the same time. Referring to FIG. 6, the voltage V₃₁ across the second electronic switch 31 can reach the on-threshold V_{31-ON} only during certain half-periods on the oscillation periods, with these certain half-periods being those half-periods, when the voltage V₃₁ reaches local maxima in the example shown in FIG. 6. During those half-periods, the voltage V_{DS} across the first electronic switch 11 also reaches local maxima, so that those half-periods are different from those half-periods in which local minima of the voltage V_{DS} occur and in which the first electronic switch 11 is switched on in the QR mode.

In the fixed frequency mode, however, switching on the first electronic switch 11 is independent of a detection of local minima of the voltage V_{DS}, so that in the fixed frequency mode a time when the first electronic switch 11 switches on may fall into a time period when the second electronic switch 31 is on the on-state because the voltage V₃₁ has reached the on-threshold V_{31-ON}.

According to one example, the control circuit 4 is therefore configured to monitor the output voltage V_{OUT} and, if a voltage level of the output voltage V_{OUT} is below a certain threshold, operate the power converter only in the variable frequency mode, such as the QR mode, but not the fixed frequency mode. According to one example, the threshold is chosen such that the oscillating voltage V₃₁ during the waiting time T_{DEL} oscillations may reach the on-threshold V_{31-ON} if the output voltage V_{OUT} is below the threshold, and the voltage V₃₁ may not reach the on-threshold V_{31-ON} if the output voltage V_{OUT} is higher than the threshold.

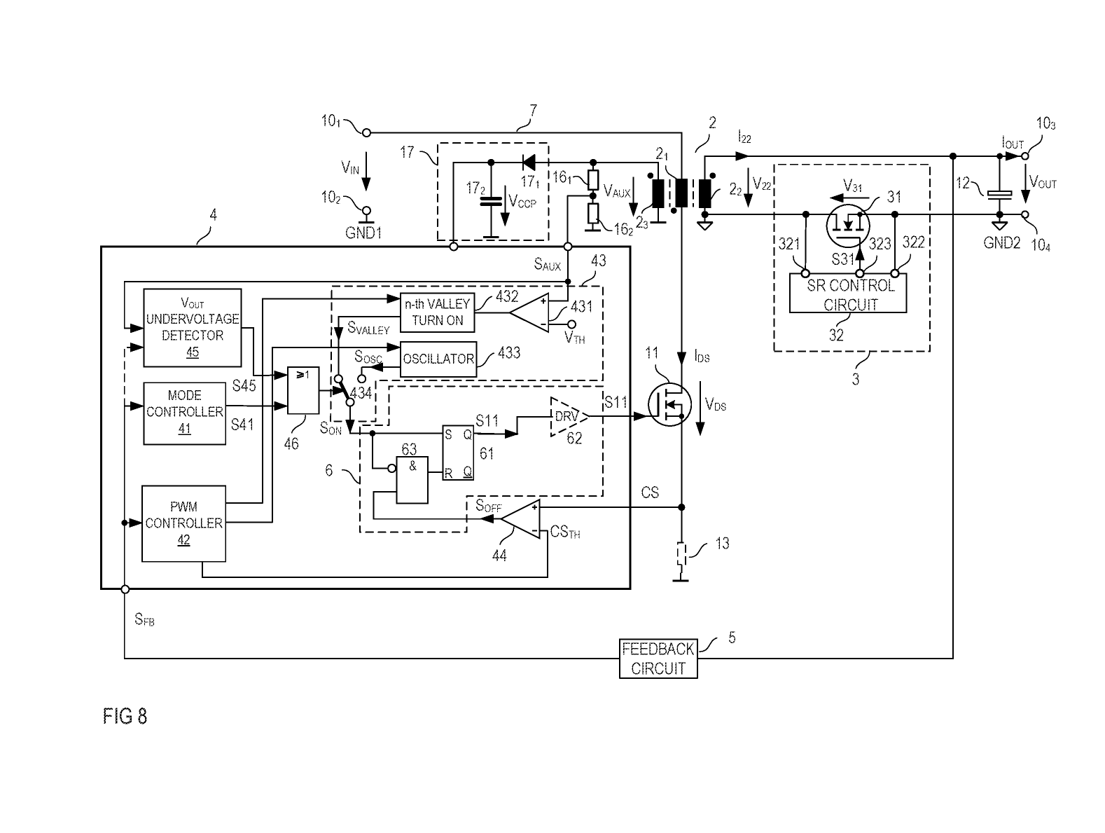

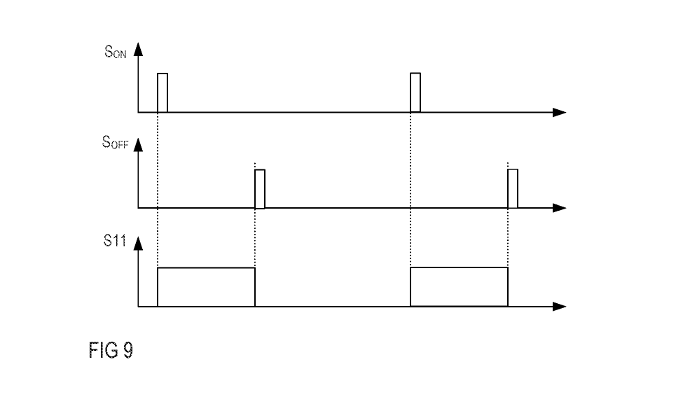

FIG. 8 shows one example of a first control circuit 4. This first control circuit is configured to operate the power converter based on the feedback signal S_{FB} and based on a voltage level of the output voltage V_{OUT}. In particular, the control circuit 4 is configured to operate the power converter in a first operation mode when a voltage level of the output voltage V_{OUT} is below a predefined threshold, and based on the feedback signal S_{FB} in one of the first operation mode and a second operation mode if the voltage level of the output voltage V_{OUT} is above the predefined threshold. According to one example, the first operation mode is a variable frequency mode such as a QR mode explained above, and the second operation mode is a fixed frequency mode.

FIG. 8 shows a block diagram of the first control circuit 4. It should be noted that this block diagram illustrates the functional blocks of the first control circuit 4 rather than a specific implementation of the first control circuit 4. Those functional blocks can be implemented in various ways. According to one example, these functional blocks are implemented using dedicated circuitry. According to another example, the first control circuit 4 is implemented using hardware and software. For example, the first control circuit 4 includes a microcontroller and software running on the microcontroller.

Referring to FIG. 8, the first control circuit 4 includes an output circuit 6 configured to generate the first drive signal S11 based on an on-signal S_{ON} and an off-signal S_{OFF}. One way of operation of the output circuit 6 is shown in FIG. 9 which illustrates signal diagrams of the on-signal S_{ON}, the off-signal S_{OFF} and the first drive signal S11. Referring to FIG. 9, each of the on-signal S_{ON} and the off-signal S_{OFF} includes signal pulses, wherein the output circuit 6 is configured to switch on the first electronic switch 11 by generating the on-level of the first drive signal S11 when a signal pulse of the on-signal S_{ON} occurs, and switch off the first electronic switch 11 by generating the off-level of the drive signal S11 when a signal pulse of the off-signal S_{OFF} occurs. This functionality can be realized in many different ways. FIG. 8 shows only one example of an output circuit 6 that operates in accordance with the timing diagrams shown in FIG. 9.

In the example shown in FIG. 8, the output circuit 6 includes a flip-flop 61, in particular an SR flip-flop, that receives the on-signal S_{ON} at a set input S and generates the first drive signal S11 at a non-inverting output S11. Optionally, a driver 62 (illustrated in dashed lines) is connected between the flip-flop 61 and the gate node of the first electronic switch 11. This driver 62 is configured to generate from the output signal S11 of the flip-flop 61 a signal with a signal level suitable to drive the first electronic switch 11. The flip-flop 61 may receive the off-signal S_{OFF} at a reset input. Alternatively, as shown in FIG. 8, the reset input R of the flip-flop receives an output signal of an AND gate 63 that receives the on-signal S_{ON} at an inverting input and the off-signal S_{OFF} at a non-inverting input. This AND gate 63 implements a blanking time in the generation of the first drive signal S11 in that flip-flop 61 cannot be reset by the off-signal S_{OFF} as long as the on-signal S_{ON} has a high-level. Referring to the explanation below, the off-signal S_{OFF} is generated by comparing a current sense signal CS with a reference signal. Shortly after the first electronic switch 11 switches on voltage spikes of the current sense signal may occur, wherein such voltage spikes may result in signal pulses of the off-signal S_{OFF}. The AND gate 63 blanks out those signal pulses of the off-signal S_{OFF} and therefore prevents the first drive signal S11 from switching off the first electronic switch 11 due to parasitic voltage spikes that may occur in the current sense signal CS.

Referring to FIG. 8, the first control circuit 4 includes a mode controller 41 that receives the feedback signal S and outputs a mode signal S41. If the output voltage V_{OUT} is above the threshold the mode signal S41 defines the operation mode of the power converter. That is, the mode signal S41 defines if the power converter operates in the first operation mode or the second operation mode. The mode controller 41 generates the mode signal S41 based on the feedback signal S. Referring to the above, the feedback signal S indicates a power consumption of the load Z (see FIG. 1). According to one example, the mode controller 41 causes the power converter to operate in the second operation mode (fixed frequency mode) if the feedback signal S is below a predefined threshold, and in the first operation mode (variable frequency mode) if the feedback signal S is above the threshold. In this way, the mode controller 41 causes the power converter to operate in the fixed frequency mode if the power consumption of the load Z is below a predefined power consumption defined by the feedback signal threshold, and in the variable frequency mode if the power consumption is higher than the predefined power consumption defined by the feedback signal threshold.

An on-circuit 43 generates the on-signal S_{ON}. The on-circuit 43 is configured to generate the on-signal S_{ON} based on an oscillator signal S_{OSC} in the fixed frequency mode and based on a valley signal S_{VALLEY} from a valley detection circuit 431, 432 in the variable frequency mode. The valley detector includes a comparator 431 that receives the auxiliary voltage V_{AUX} or a signal proportional to the auxiliary voltage. In the example shown in FIG. 8, the comparator 431 receives a signal proportional to the auxiliary voltage V_{AUX} from a voltage divider 16₁, 16₂ that receives the auxiliary voltage V_{AUX} as an input signal. In the following, the signal provided by the voltage divider 16₁, 16₂ is referred to as auxiliary signal S_{AUX}. The comparator 431 compares the auxiliary signal S_{AUX} with a threshold S_{AUX-TH}. According to one example, the threshold S_{AUX-TH} is zero, so that the comparator 431 detects zero crossings of the auxiliary voltage V_{AUX}. An evaluation circuit (valley selection circuit) 432 receives an output signal from the comparator 431 and, based on the comparator output signal and a signal Sₙ received from a PWM controller 42 generates the valley signal S_{VALLEY}. The signal Sₙ received from the PWM controller 42 defines the waiting time, that is, defines at which local minimum after the demagnetization period T_{DEMAG}, the first electronic switch 11 is expected to switch on. The evaluation circuit 432 generates a signal pulse of the valley signal S_{VALLEY} at that time at which the local minimum defined by the signal Sₙ occurs. The evaluation circuit 432 may calculate the positions in time at which minima occur based on positions in time of the zero crossings as represented by the input signal (S_{DIS} in FIG. 9) of the evaluation circuit 432 in the way explained with reference to FIG. 6.

An off-circuit that generates the off-signal S_{OFF} includes a further comparator 44 that compares a current signal CS with a current threshold CS_{TH} and outputs the off-signal S_{OFF}. The current signal CS represents the load current I_{DS} through the first electronic switch 11. This load current I_{DS} increases substantially linearly when the first electronic switch 11 switches on. When the current signal CS reaches the threshold CS_{TH}, the off-signal S_{OFF} has a signal pulse that causes the output stage 6 to switch off the first electronic switch 11. For example, the current signal CS is generated by a sense resistor 13 connected in series with the first electronic switch 11. By sensing the load current I_{DS}, the first control circuit 4 operates the power converter circuit in a current mode. This, however, is only an example. According to another example (not shown) the comparator 44 receives a ramp signal generated by a ramp generator such that the ramp signal increases each time the first electronic switch 11 switches on.

The current threshold CS_{TH} is generated by the PWM controller 42 based on the feedback signal S_{FB} such that the current threshold CS_{TH} increases as the power consumption of the load indicated by the feedback signal S_{FB} increases. An increase of the current threshold CS_{TH} increases the on-period T_{ON} and, therefore, increases the power consumption (input power) of the power converter circuit, so as to regulate the output voltage V_{OUT}. The input power of the power converter circuit is given by the input voltage V_{IN} multiplied with the average load current I_{DS}. According to one example, the PWM controller 42 is further configured to limit the current I_{DS} through the first electronic switch 11 by preventing the current threshold CS_{TH} to rise above a predefined maximum value. That is, the current threshold CS_{TH} does not rise above the maximum value even if the power consumption of the load Z would require such increase.

According to one example, the PWM controller 42 is further configured to adjust a frequency of the oscillator in the on-circuit 43 based on the feedback signal S_{FB}. For example, the PWM controller 42 is configured to reduce the frequency of the oscillation signal S_{OSC} if the feedback signal S_{FB} falls below a predefined threshold indicating that a power consumption of the load is low. Nevertheless, an operation mode of the first control circuit 4 in which the duration of drive cycles of the targeted drive signal S6 is defined by the oscillator (and independent of a charging state of the transformer and/or a load path voltage V_{DS} of the first electronic switch 11) is referred to as fixed frequency mode in the following.

The first control circuit 4 further includes an undervoltage detector 45 that detects if the voltage level of the output voltage V_{OUT} is below or above the predefined threshold (undervoltage threshold). In the example shown in FIG. 8, the undervoltage detector 45 receives the auxiliary signal S_{AUX} and detects the voltage level of the output voltage V_{OUT} based on the auxiliary signal S_{AUX}. According to one example, the undervoltage detector 45 detects the output voltage V_{OUT} by sampling the auxiliary signal S_{AUX} during the demagnetization period T_{DEMAG}. During the demagnetization period T_{DEMAG}, the auxiliary voltage V_{AUX} is proportional to a voltage given by the output voltage V_{OUT} plus the voltage V₃₁ across the rectifier circuit 31, with a proportionality factor being given by a winding ratio between a number of windings N_{AUX} of the auxiliary winding 2₃ and a number of windings N₂₂ the secondary winding 2₂, that is,

V_{AUX}=(N_{AUX}/N₂₂)·(V_{OUT}+V₃₁) (3a).

The output voltage V_{OUT} is then given by

V_{OUT}=V_{AUX}·(N₂₂/N_{AUX})−V₃₁ (3b).

According to one example, the power converter circuit is designed such that the voltage V₃₁ across the rectifier element 31 is much smaller than the predefined threshold. In this case, V₃₁ can be neglected in equation (3) and V_{AUX} can be considered to be substantially proportional to the output voltage V_{OUT} when V_{OUT} is in the range of the predefined threshold. In this case, the undervoltage detector 45 can be configured to detect whether or not the output voltage V_{OUT} is below the predefined threshold by comparing the auxiliary signal S_{AUX}, which is proportional to the auxiliary voltage V_{AUX}, with a threshold that represents the undervoltage threshold. The threshold used by the undervoltage detector 45 is proportional to the undervoltage threshold in the same way the auxiliary signal S_{AUX} is proportional to the output voltage V_{OUT}.

Referring to FIG. 6, the output current I_{OUT} decreases over the demagnetization time T_{DEMAG} so that the voltage V₃₁ across the rectifier element 31 decreases over the demagnetization time T_{DEMAG}. During the demagnetization time T_{DEMAG}, the voltage V₃₁ is substantially given by the output current I_{OUT} multiplied with an on-resistance of the rectifier element 31. The on-resistance is substantially constant so that V₃₁ is substantially proportional to the output current I_{OUT} during the demagnetization time T_{DEMAG}. During the demagnetization time T_{DEMAG}, the output I_{OUT} decreases substantially linearly and the average output current I_{OUT} is dependent on a power consumption of the load Z. By virtue of the output current linearly decreasing and by virtue of the average being dependent on the power consumption of the load Z, the instantaneous level of the output current I_{OUT} at a time instant a predefined time period after the beginning of the demagnetization period T_{DEMAG} is also dependent on the power consumption of the load Z. The power consumption of the load Z is represented by the feedback signal S_{F}. Thus, according to one example (illustrated in dashed lines in FIG. 8), the undervoltage detector 45 receives the feedback signal S_{RB}, samples the auxiliary signal S_{AUX} a predefined time period after the beginning of the demagnetization period, estimates the voltage V₃₁ across the rectifier element 31 at the sampling time based on the feedback signal S_{FB}, and calculate the output voltage V_{OUT} based on the sample value obtained by sampling the auxiliary signal S_{AUX} and the estimated value of V₃₁.

As the auxiliary signal S_{AUX} is proportional to the auxiliary voltage V_{AUX}, by sampling the auxiliary signal S_{AUX} an information on the voltage level of the auxiliary voltage V_{AUX} and, taking into account, equations (3a) and (3b), an information on the output voltage V_{OUT} can be obtained by the undervoltage detector 45. Thus, the undervoltage detector 45 based on the auxiliary signal S_{AUX} can detect whether or not the output voltage V_{OUT} is below the predefined threshold.

Undervoltage detector 45 generates an undervoltage signal S45 that indicates whether the output voltage V_{OUT} is below or above the predefined threshold. A logic gate 46 receives the mode signal S41 and the undervoltage signal S45 and selects the first operation mode or the second operation mode based on these signal S41, S45. In the first control circuit 4 shown in FIG. 8, selecting the first operation mode or the second operation mode includes selecting the valley signal S_{VALLEY} or the oscillator signal S_{OSC} as the on-signal S_{ON}. In FIG. 8, this is illustrated by having a switch 434 connected between the evaluation circuit 432, the oscillator 433 and the output circuit 6, and controlled by an output signal of the logic gate 46, whereas the switch 434 either directs the oscillator signal S_{OSC} or the valley signal S_{VALLEY} to the output of the on-circuit 43. The logic gate 46 is selected such that the mode signal S41 defines the operation mode of the on-circuit 43 if the undervoltage signal S45 indicates that the output voltage V_{OUT} is above the predefined threshold. If the undervoltage signal S45 indicates that the output voltage V_{OUT} is below the threshold, the logic gate 46 forces the on-circuit 43 into the first operation mode (variable frequency mode). For example, the logic gate 46 is an OR-gate and a high level of the output signal of the logic gate 46 causes the on-circuit 43 to operate in the variable frequency mode. In this example, a high-level of the under voltage signal S45 indicates that the output voltage V_{OUT} is below the predefined threshold and a high-level of the mode signal S41 indicates that it is desired to operate the power converter in the variable frequency mode. In this case, the power converter circuit is operated in the variable frequency mode if at least one of the under voltage signal S45 and the mode signal S41 has a high signal level.

Referring to FIG. 8, the first auxiliary voltage V_{AUX} may not only be used to detect local minima of the load path voltage V_{DS}, but also to supply the first control circuit 4. For this, a rectifier circuit with a rectifier element 17₁, such as a diode, and a capacitor 17₂ are connected to the first auxiliary winding 2₃. A supply voltage V_{CCP} across is available across the capacitor 17₂ and received by the first control circuit 4 at a supply input.

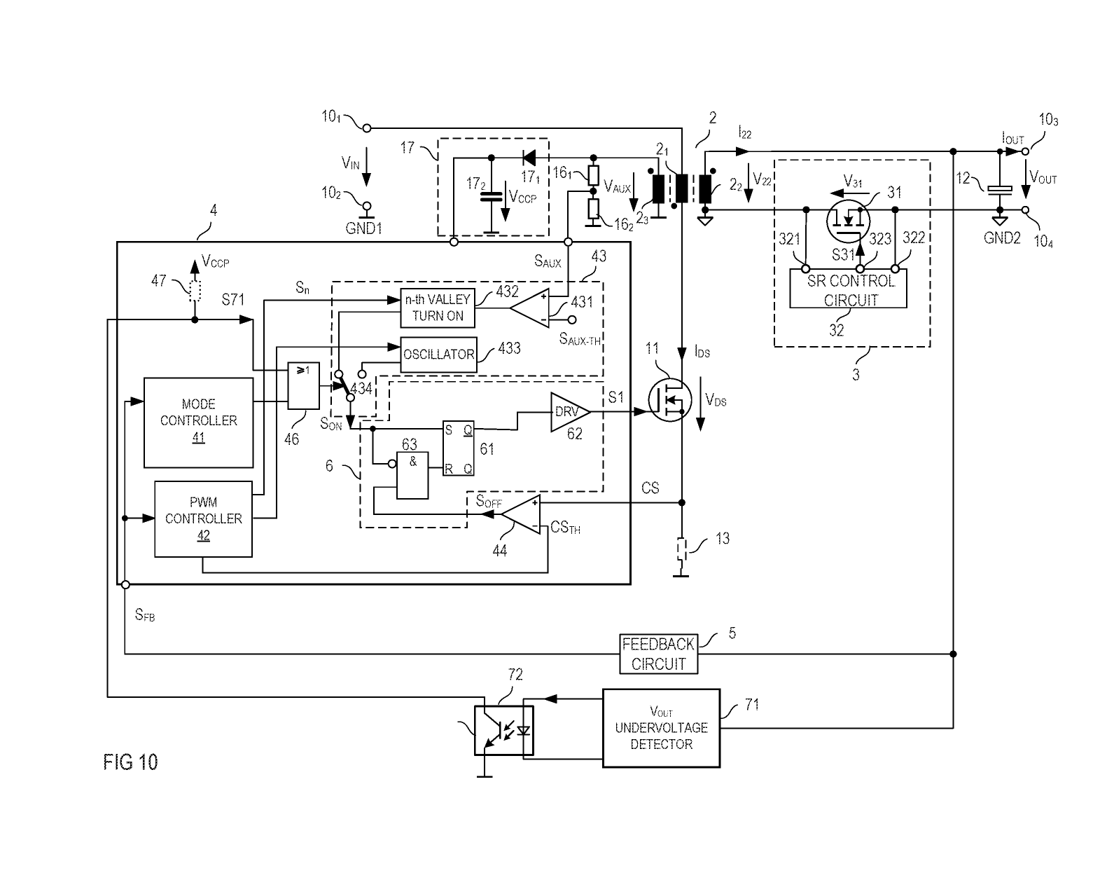

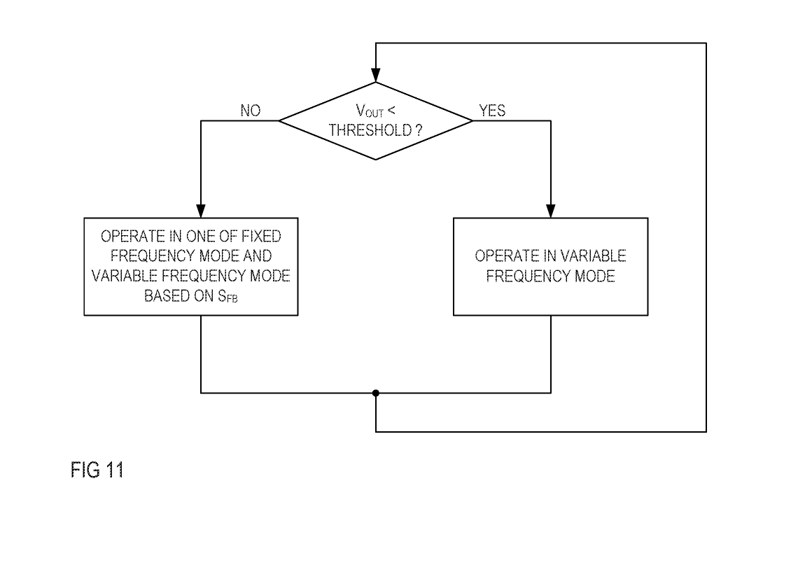

FIG. 10 shows a power converter circuit according to another example. In this example, an undervoltage detector 71 is arranged on the secondary side of the power converter and generates an under voltage signal S71 based on comparing the output voltage V_{OUT} with the predefined threshold. A transmitter 72, such as an optocoupler transmits the undervoltage signal S71 from the secondary side to the primary side and to the first control circuit 4 where the logic gate 46 receives the under voltage signal S71 and the mode signal S41. Like the undervoltage signal S45 explained in FIG. 8, the undervoltage signal S71 indicates whether the output voltage V_{OUT} is below or above the predefined threshold, so that the operation of the first control circuit 4 shown in FIG. 10 equals the operation of the first control circuit 4 shown in FIG. 8.

The operation of the power converter circuit in the first operation mode or the second operation mode based on the feedback signal S_{FB} and the voltage level of the output voltage V_{OUT} is illustrated in FIG. 11. According to FIG. 11, the power converter circuit detects if the output voltage V_{OUT} is below a predefined threshold. If the output voltage V_{OUT} is below the predefined threshold, the power converter circuit operates in a variable frequency mode. If not, the power converter circuit either operates in the variable frequency mode or the fixed frequency mode dependent on the feedback signal S_{FB}.

Although various exemplary examples of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

Spatially relative terms such as “under,” “below,” “lower,” “over,” “upper” and the like, are used for ease of description to explain the positioning of one element relative to a second element. These terms are intended to encompass different orientations of the device in addition to different orientations than those depicted in the figures. Further, terms such as “first,” “second” and the like, are also used to describe various elements, regions, sections, etc. and are also not intended to be limiting. Like terms refer to like elements throughout the description.

As used herein, the terms “having,” “containing,” “including,” “comprising” and the like are open ended terms that indicate the presence of stated elements or features, but do not preclude additional elements or features. The articles “a,” “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A power converter circuit comprising:
a transformer comprising a primary winding and a secondary winding;
a first electronic switch connected in series with the primary winding;
a rectifier circuit connected between the secondary winding and an output, wherein the rectifier circuit comprises a second electronic switch;
a feedback circuit coupled to the output and configured to generate a feedback signal based on an output signal available at the output; and
a first control circuit configured to operate the power converter circuit in one of a first operation mode and a second operation mode based on the feedback signal and a signal level of the output signal.

2. The power converter circuit of claim 1, wherein the output signal is an output voltage.

3. The power converter circuit of claim 1, wherein the first control circuit is configured
to operate the power converter circuit in the first operation mode when a signal level of the output signal is below a predefined threshold, and
to operate the power converter circuit in one of the first operation mode and the second operation mode based on the feedback signal if the signal level of the output signal is above the threshold.

4. The power converter circuit of claim 1,
wherein the transformer further comprises an auxiliary winding, and
wherein the first control circuit is configured to detect a signal level of the output signal based on a voltage across the auxiliary winding.

5. The power converter circuit of claim 4, wherein the first control circuit is configured to detect the signal level of the output signal based on sampling the voltage across the auxiliary winding during a demagnetization period of the transformer.

6. The power converter circuit of claim 5, wherein the first control circuit being configured to detect the signal level of the output signal based on sampling the voltage across the auxiliary winding during a demagnetization period of the transformer comprises the first control circuit being configured to sample the voltage across the auxiliary winding after a predefined time period after a beginning of the demagnetization period.

7. The power converter circuit of claim 4,
wherein the first control circuit is configured to detect a signal level of the output signal based on a voltage across the auxiliary winding comprises the first control circuit being configured to detect a signal level of the output signal based on a voltage across the auxiliary winding and the feedback signal.

8. The power converter circuit of claim 1, further comprising:
a further feedback circuit coupled to the output and configured to provide a further feedback signal to the first control circuit, wherein the further feedback signal includes an information on the signal level of the output signal.

9. The power converter circuit of claim 1, wherein the first operation mode is a fixed frequency mode and the second operation mode is a variable frequency mode.

10. The power converter circuit of claim 9, wherein the first control circuit is configured
in the fixed frequency mode to switch on the first electronic switch at a predefined fixed frequency; and
in the variable frequency mode to switch on the first electronic switch at a variable frequency.

11. The power converter circuit of claim 10, wherein the first control circuit, in the variable frequency mode, is configured to detect a voltage across the first electronic switch and select a time for switching on the first electronic switch based on the voltage across the first electronic switch.

12. The power converter circuit of claim 11, wherein the first control circuit is configured to
detect times when local minima of the voltage across the first electronic switch occur, and
switch on the first electronic switch at one of these times.

13. The power converter circuit of claim 1, wherein the rectifier circuit further comprises a second control circuit configured to control the second electronic switch based on a voltage across the second electronic switch.

14. The power converter circuit of claim 13, wherein the second control circuit is configured to
switch on the second electronic switch when the voltage across the second electronic switch has a first polarity and the absolute value of the voltage rises above a first threshold, and
switch off the second electronic switch when the voltage across the second electronic switch has a first polarity and the absolute value of the voltage falls below a second threshold lower than the first threshold.

15. The power converter circuit of claim 14, wherein the second control circuit is further configured to keep the second electronic switch switched off for a predefined off-period after the absolute value of the voltage has fallen below the second threshold.

16. The power converter circuit of claim 15, wherein the rectifier circuit further comprises an auxiliary power supply configured to supply power to the second control circuit,
wherein the auxiliary power supply comprises an auxiliary winding of the transformer.

17. The power converter circuit of claim 1, wherein the primary winding and the secondary winding have opposite winding senses.

18. A power conversion method, comprising:
operating a power converter circuit in one of a first operation mode and a second operation mode based on a feedback signal and a signal level of an output signal at an output,
wherein the power converter circuit comprises: a transformer with a primary winding and a secondary winding, a first electronic switch connected in series with the primary winding, and a rectifier circuit connected between the secondary winding and the output and comprising a second electronic switch, and
wherein the feedback signal is dependent on the output signal.

19. The method of claim 18, wherein the output signal is an output voltage.

20. The method of claim 18, further comprising:
operating the power converter circuit in the first operation mode when a signal level of the output signal is below a predefined threshold, and
operating the power converter circuit in one of the first operation mode and the second operation mode based on the feedback signal if the signal level of the output signal is above the threshold.

21. The method of claim 20,
wherein the transformer further comprises an auxiliary winding, and
wherein the method further comprises detecting a signal level of the output signal based on a voltage across the auxiliary winding.

22. The method of claim 21, wherein detecting the signal level of the output signal based on a voltage across the auxiliary winding comprises sampling the voltage across the auxiliary winding during a demagnetization period of the transformer.

23. The method of claim 22, wherein sampling the voltage across the auxiliary winding during a demagnetization period of the transformer comprises sampling the voltage across the auxiliary winding after a predefined time period after a beginning of the demagnetization period.

24. The method of claim 21,
wherein detecting a signal level of the output signal based on a voltage across the auxiliary winding comprises detect a signal level of the output signal based on a voltage across the auxiliary winding and the feedback signal.

25. The method of claim 18, wherein the first operation mode is a fixed frequency mode and the second operation mode is a variable frequency mode.

26. The method of claim 25,
wherein operating the power converter circuit in the fixed frequency mode comprises switching on the first electronic switch at a predefined fixed frequency; and
wherein operating the power converter circuit in the variable frequency mode comprises switching on the first electronic switch at a variable frequency.

27. The method of claim 26, wherein operating the power converter circuit in the variable frequency mode comprises detecting a voltage across the first electronic switch and selecting a time for switching on the first electronic switch based on the voltage across the first electronic switch.

28. The method of claim 27,
wherein selecting a time for switching on the first electronic switch based on the voltage across the first electronic switch comprises detecting times when local minima of the voltage across the first electronic switch occur, and
wherein the method further comprises switching on the first electronic switch at one of these times.

29. The method of claim 18, further comprising:
controlling the second electronic switch based on a voltage across the second electronic switch.

30. The method of claim 29, wherein controlling the second electronic switch based on a voltage across the second electronic switch comprises:
switching on the second electronic switch when the voltage across the second electronic switch has a first polarity and the absolute value of the voltage rises above a first threshold; and
switching off the second electronic switch when the voltage across the second electronic switch has a first polarity and the absolute value of the voltage falls below a second threshold lower than the first threshold.

31. The method of claim 30, wherein controlling the second electronic switch based on a voltage across the second electronic switch further comprises:
keeping the second electronic switch switched off for a predefined off-period after the absolute value of the voltage has fallen below the second threshold.

32. The method of claim 18, further comprising:
supplying power to the rectifier circuit from an auxiliary power supply, wherein the auxiliary power supply comprises an auxiliary winding of the transformer.

33. The method of claim 18, wherein the primary winding and the secondary winding have opposite winding senses.
